(19) United States
(12) Patent Application Publication
(10) Pub. No.: US 2004/0014840 A1
(43) Pub. Date: Jan. 22, 2004

(54) Rubber compositions and methods for improving scorch safety and hysteretic properties of the compositions

(75) Inventors: Sung W. Hong, Cheshire, CT (US); Robert J. Cornell, Prospect, CT (US)

Correspondence Address: Kenneth D. Tremain, Crompton Corporation, Benson Road, Middlebury, CT, 06749, US

(73) Assignee: UNIROYAL CHEMICAL COMPANY

(21) Appl. No.: 10/194,553

(22) Filed: Jul. 11, 2002

(51) Int. Cl. C08K 3/34; C08K 9/00

(52) U.S. Cl. 523/216; 524/492

(57) ABSTRACT

A rubber composition comprising (a) a rubber component; (b) silica as a reinforcing filler; (c) a reinforcing additive comprising a mixture and/or the product of in situ reaction of (i) at least one functionalized mercaptosilane compound containing, per molecule, at least one functional group capable of bonding chemically and/or physically with the surface hydroxyl sites of the silica filler and at least one other functional group capable of bonding chemically and/or physically to the chains of the rubber component and (ii) at least one functionalized organosilane compound, other than a mercaptosilane compound, containing, per molecule, at least one functional group capable of bonding chemically and/or physically with the mercaptosilane compound and/or the hydroxyl sites of the silica filler and at least one other functional group capable of bonding chemically and/or physically to the chains of the rubber component; and (d) an effective amount of a thiuram disulfide accelerator having a molecular weight of at least about 400 is provided.

### BACKGROUND OF THE INVENTION

1. Technical Field

This invention generally relates to rubber compositions and methods for making rubber compositions having improved scorch safety and hysteretic properties (e.g., tangent delta value). The rubber compositions are particularly useful for tire tread applications in vehicles, e.g., passenger automobiles and trucks.

2. Description of the Related Art

The tire treads of modern tires must meet performance standards which require a broad range of desirable properties. Generally, three types of performance standards are important in tread compounds. They include good wear resistance, good traction and low rolling resistance. Major tire manufacturers have developed tire tread compounds which provide lower rolling resistance for improved fuel economy and better skid/traction for a safer ride. Thus, rubber compositions suitable for, e.g., tire treads, should exhibit not only desirable strength and elongation, particularly at high temperatures, but also good cracking resistance, good abrasion resistance, desirable skid resistance, low tangent delta values at 60° C. and low frequencies for desirable rolling resistance of the resulting treads. Additionally, a high complex dynamic modulus is necessary for maneuverability and steering control. A high Mooney Scorch value is further needed for processing safety.

Presently, silica has been added to rubber compositions as a reinforcing filler to replace some or substantially all of the carbon black filler to improve these properties, e.g., lower rolling resistance. Although more costly than carbon black, the advantages of silica include, for example, improved wet traction and low rolling resistance (which results in reduced fuel consumption). Indeed, as compared to carbon black, there tends to be a lack of, or at least an insufficient degree of, physical and/or chemical bonding between the silica particles and the rubber to enable the silica to become a reinforcing filler for the rubber. Accordingly, the silica particles have an unfortunate tendency, in the rubber matrix, to agglomerate together. Thus, the silica/silica interactions have the detrimental consequence of limiting the reinforcing properties to a level which is appreciably lower than that which it would be theoretically possible to attain if all the silica/rubber interactions capable of being created during the mixing operation were actually obtained. This results in giving less strength to the tire.

What is more, the use of silica gives rise to difficulties in processing which are due to the silica/silica interactions which tend, in the raw state (before curing), to increase the consistency of the rubbery compositions and, in any event, to make the processing more difficult than the processing of carbon black. Other drawbacks associated with the use of silica include (1) the time necessary for mixing increases to improve dispersion of silica into rubber, (2) the Mooney viscosity of a rubber composition containing silica increases due to the insufficient dispersion of silica into rubber, and (3) workability in processing such as extrusion becomes poor. Yet another drawback is that since the surface of a silica particle is acidic, basic substances used as a vulcanization accelerator is adsorbed on its surface. This results in an insufficient vulcanization which leads to an undesirably low modulus value.

To overcome the above drawbacks, coupling agents have been developed to enhance the rubber reinforcement characteristics of silica by reacting with both the silica surface and the rubber molecule. Such coupling agents, for example, may be premixed or pre-reacted with the silica particles or added to the rubber mix during the rubber/silica processing, or mixing, stage. If the coupling agent and silica are added separately to the rubber mix during the rubber/silica processing, or mixing, stage, it is considered that the coupling agent then combines in situ with the silica.

One objective of a person skilled in the art, however, consists in improving the processing of the rubber compositions containing silica as a reinforcing filler and, on the other hand, to reduce the quantity of coupling agent needed, without degrading the properties of such compositions.

Generally, coupling agents act as reinforcing additives by reacting with the silica at one end thereof and cross-linking with the rubber at the other end. In this manner, the reinforcement and strength of the rubber, e.g., the toughness, strength, modulus, tensile and abrasion resistance, are particularly improved. The coupling agent is believed to cover the surface of the silica particle which then hinders the silica from agglomerating with other silica particles. By interfering with the agglomeration process, the dispersion is improved and therefore reduced wear and reduced fuel consumption are achieved.

The majority of the sulfur-containing coupling agents which have been used in rubber compositions involve silanes containing, for example, one or more of the following chemical bond types: S—H (mercapto), S—S (disulfide or polysulfide), or C═S (thiocarbonyl). Mercaptosilanes, as compared to other coupling agents such as disulfide silanes and thiocarbonyl silanes, have offered superior coupling at substantially reduced hysteresis. However, their high chemical reactivity leads to unacceptably high viscosities during processing and premature curing. As a result, scorch safety is an issue with the use of mercaptosilane coupling agents with silica filled rubber compositions.

It would therefore be desirable to provide rubber compositions employing coupling agents such that the rubber compositions have improved scorch safety without sacrificing other physical properties such as hysteresis. This will allow for better processing of the rubber composition during its manufacture.

### SUMMARY OF THE INVENTION

It is, therefore, an object of the present invention to provide rubber compositions having improved scorch safety.

It is also an object of the present invention to provide rubber composition having improved hysteretic properties, e.g., a lower tangent delta value.

In keeping with these and other objects of the present invention, a rubber composition is provided which comprises (a) a rubber component; (b) silica as a reinforcing filler; (c) a reinforcing additive comprising a mixture and/or the product of in situ reaction of (i) at least one functionalized mercaptosilane compound containing, per molecule, at least one functional group capable of bonding chemically and/or physically with the surface hydroxyl sites of the silica filler and at least one other functional group capable of bonding chemically and/or physically to the chains of the rubber component and (ii) at least one functionalized organosilane compound, other than a functionalized mercaptosilane compound, containing, per molecule, at least one functional group capable of bonding chemically and/or physically with the mercaptosilane compound and/or the hydroxyl sites of the silica filler and at least one other functional group capable of bonding chemically and/or physically to the chains of the rubber component; and (d) an effective amount of a thiuram disulfide accelerator having a molecular weight of at least about 400.

Another embodiment of the present invention is semifinished constituents which can be employed in the manufacture of tires, especially of treads, and tires which have improved hysteretic properties, obtained by the use of a rubber composition according to the invention embodying silica as a reinforcing filler.

Yet another embodiment of the present invention is a method for improving the scorch safety and hysteretic properties of silica-reinforced rubber compositions.

The rubber compositions herein containing a mixture and/or the product of in situ reaction of one or more meraptosilane compounds and one or more organosilane compounds other than a meraptosilane compound together with an effective amount of a high molecular weight thiuram disulfide, e.g., a thiuram disulfide having a weight average molecular weight (M_{w}) of at least 400, results in the compositions advantageously possessing an increased scorch safety and a reduced hysteresis. Accordingly, the delay in cure/vulcanization of rubber observed with the use of silica and reinforcing additives alone as noted above has been lessened, if not substantively overcome, in many cases by the effective amount of the thiuram disulfides of the present invention. Thus, the thiuram disulfides herein have been found to increase the cure rate and, in some instances, to fully recapture any cure slow down presumed to have resulted from the use of the silica with the blend of reinforcing additives alone while also increasing the scorch safety of the rubber composition. In this manner, the mixture of reinforcing additives together with an effective amount of the thiuram disulfide have enabled achievement of the silica benefits in full without the prior art disadvantage.

Additionally, by employing a high molecular weight thiuram disulfide environmentally undesirable nitrosamine generation is eliminated or substantially eliminated as compared to low molecular weight thiuram disulfides. Accordingly, environmental concerns are avoided.

The term “phr” is used herein as its art-recognized sense, i.e., as referring to parts of a respective material per one hundred (100) parts by weight of rubber.

### DESCRIPTION OF THE PREFERRED EMBODIMENTS

The rubber components for use herein are based on highly unsaturated rubbers such as, for example, natural or synthetic rubbers. Representative of the highly unsaturated polymers that can be employed in the practice of this invention are diene rubbers. Such rubbers will ordinarily possess an iodine number of between about 20 to about 450, although highly unsaturated rubbers having a higher or a lower (e.g., of 50-100) iodine number can also be employed. Illustrative of the diene rubbers that can be utilized are polymers based on conjugated dienes such as, for example, 1,3-butadiene; 2-methyl-1,3-butadiene; 1,3-pentadiene; 2,3-dimethyl-1,3-butadiene; and the like, as well as copolymers of such conjugated dienes with monomers such as, for example, styrene, alpha-methylstyrene, acetylene, e.g., vinyl acetylene, acrylonitrile, methacrylonitrile, methyl acrylate, ethyl acrylate, methyl methacrylate, ethyl methacrylate, vinyl acetate, and the like. Preferred highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly (acrylonitrile-butadiene). Moreover, mixtures of two or more highly unsaturated rubbers with elastomers having lesser unsaturation such as EPDM, EPR, butyl or halogenated butyl rubbers are also within the contemplation of the invention.

The silica for use as a reinforcing filler in the rubber compositions of the present invention may be of any type that is known to be useful in connection with the reinforcing of rubber compositions. Examples of suitable silica fillers include, but are not limited to, silica, precipitated silica, amorphous silica, vitreous silica, fumed silica, fused silica, synthetic silicates such as aluminum silicates, alkaline earth metal silicates such as magnesium silicate and calcium silicate, natural silicates such as kaolin and other naturally occurring silicas and the like. Also useful are highly dispersed silicas having, e.g., BET surfaces of from about 5 to about 1000 m²/g and preferably from about 20 to about 400 m²/g and primary particle diameters of from about 5 to about 500 nm and preferably from about 10 to about 400 nm. These highly dispersed silicas can be prepared by, for example, precipitation of solutions of silicates or by flame hydrolysis of silicon halides. The silicas can also be present in the form of mixed oxides with other metal oxides such as, for example, Al, Mg, Ca, Ba, Zn, Zr, Ti oxides and the like. Commercially available silica fillers known to one skilled in the art include, e.g., those available from such sources as Cabot Corporation under the Cab-O-Sil® tradename; PPG Industries under the Hi-Sil and Ceptane tradenames; Rhodia under the Zeosil tradename and Degussa AG under the Ultrasil and Coupsil tradenames. Mixtures of two or more silica fillers can be used in preparing the rubber composition of this invention.

Amounts of silica filler incorporated into the rubber composition can vary widely. Generally, the amount of silica filler can ordinarily range from about 5 to about 120 phr, preferably from about 10 to about 100 phr and more preferably from about 20 to about 90 phr.

If desired, carbon black fillers can also be employed in forming the rubber compositions of this invention. Suitable carbon black fillers include any of the commonly available, commercially-produced carbon blacks known to one skilled in the art. Generally, those having a surface area (EMSA) of at least about 5 m²/g, preferably at least about 35 m²/g and most preferably at least about 200 m²/g can be used herein. Surface area values used in this application are those determined by ASTM test D-3765 using the cetyltrimethyl-ammonium bromide (CTAB) technique. Among the useful carbon blacks are furnace black, channel blacks and lamp blacks. More specifically, examples of the carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which may be utilized include acetylene blacks. Mixtures of two or more of the above blacks can be used in preparing the rubber compositions of the invention. Typical values for surface areas of usable carbon blacks are summarized in the following Table I.

TABLE I
Carbon Blacks

| ASTM | Surface Area |
|---|---|
| Designation | (m²/g) |
| (D-1765-82a) | (D-3765) |
| N-110 | 126 |
| N-234 | 120 |
| N-220 | 111 |
| N-339 | 95 |
| N-330 | 83 |
| N-550 | 42 |
| N-660 | 35 |

The carbon blacks utilized in the invention may be in pelletized form or an unpelletized flocculant mass. Preferably, for ease of handling, pelletized carbon black is preferred. The carbon blacks, if any, are ordinarily incorporated into the rubber composition in amounts ranging from about 0 to about 80 phr and preferably from about 2 to about 70 phr.

The reinforcing additive employed in the rubber compositions of the present invention includes, on the one hand, one or a number of functionalized mercaptosilane compound(s) containing, per molecule, one or a number of functional group(s) capable of bonding chemically and/or physically with at least the surface hydroxyl sites of the silica filler and at least one other functional group capable of bonding chemically and/or physically to the chains of the rubber component and, on the other hand, one or a number of functionalized organosilane compound(s) other than a mercaptosilane compound(s) containing, per molecule, one or a number of functional group(s) capable of bonding chemically and/or physically with the mercaptosilane compound(s) and/or the hydroxyl sites of the silica filler and at least one functional group capable of bonding chemically and/or physically to the chains of the rubber component.

One or more compounds corresponding to the following general formula (I) are suitable as the mercaptosilane compounds which can be employed within the scope of the invention:

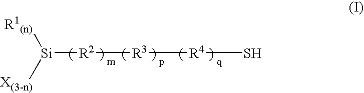

wherein R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a hydroxyl group (OH); R² is a divalent hydrocarbon group chosen from linear or branched alkyls containing from 1 to about 10 carbon atoms and advantageously from 1 to about 6 carbon atoms and m is 0 or 1; R³ is a hydrocarbon group chosen from aryls containing from about 5 to about 12 carbon atoms and preferably from about 6 to about 8 carbon atoms; with the condition that p and m are not equal to 0 simultaneously; R⁴ is

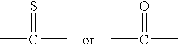

and q is 0 or 1 and SH is a group capable of forming a bond with at least one of the rubber components of the rubber composition. Suitable mercaptosilane compounds for use herein include, but are not limited to, 3-mercaptopropyltrimethoxysilane, 3-mercaptopropyltriethoxysilane, 3-mercaptopropylmethyldimethoxysilane, 2-mercaptoethyltriethoxysilane, 2-mercaptoethylmethyldiethoxysilane, mercaptomethyldimethylethoxysilane, mercaptomethyltrimethoxysilane, mercaptomethyltriethoxysilane, mercaptopropyldimethylmethoxysilane, 3-mercaptopropyl-phenyldimethoxysilane, 3-mercaptopropyltrimethylsilane, mercaptomethylmethyl-diethoxysilane, mercaptoethyltrimethoxyethoxysilane, and the like and combinations thereof. A preferred mercaptosilane compound for use herein is 3-mercaptopropyltriethoxysilane (Silquest A-1891 available from OSI Specialty Chemicals).

One or more organosilane compounds, other than a mercaptosilane compound, corresponding to the general formulae (II-V) are suitable as the organosilane compounds which can be employed within the scope of the invention:

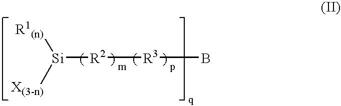

wherein R¹, R², R³, X, n, m and p have the aforestated meanings set forth in Fornula (I); q is 1 or 2 and B denotes a group other than a mercapto group and which is capable of forming a bond with at least one of the rubber components of the rubber composition herein. The preferred group B are the polysulfide (Sx) and disulfide (S₂) groups in the case of q=2 with the disulfides being most preferred.

However, the group B may also include other groups capable of reaction with the rubbery polymer, for example:

B can be as follows:

In the case of q=2: a polysulfured functional group chosen from the following groups:

—Sx— with 1≦x≦8 and x is a positive integer,

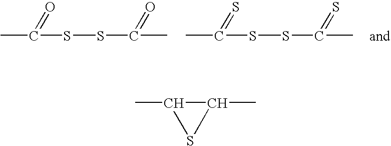

In the case of q=1: a function group chosen from the following groups:

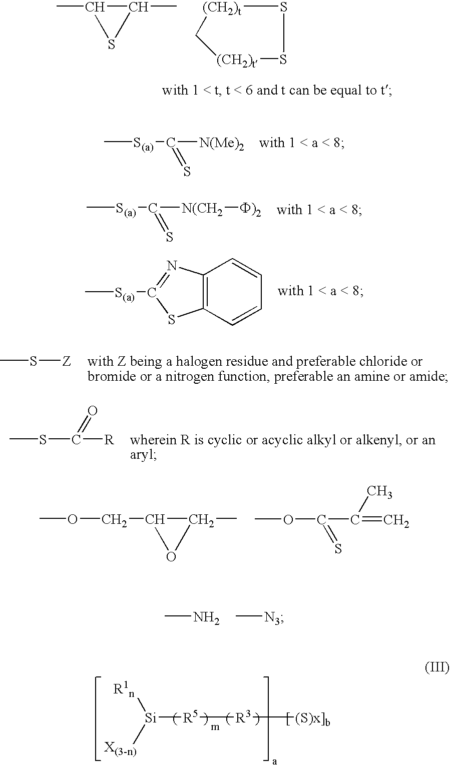

in which R¹ and X have the aforestated meanings as set forth in Formula (I), 0≦x≦2, R⁵ denotes a divalent hydrocarbon group chosen from linear or branched alkyls and alkylenoxys, containing from 1 to about 10 carbon atoms and advantageously from 1 to about 6, m denotes 0 or 1, R³ denotes a hydrocarbon group chosen from aryls containing from about 6 to about 12 carbon atoms, and (S)ₓ is a divalent polysulfured radical, each free valency being bonded directly to a carbon atom of an aromatic ring, it being possible for a number of aromatic rings to be linked together by the radical (S)ₓ, 2≦x≦6, a≧2 and b≧1 with 0.4≦a/b≦2;

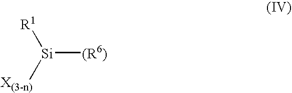

in which R¹ and X have the aforestated meanings as set forth in Formula I, 0≦n≦2, R⁶ is a linear or branched hydrocarbon group, cyclic or otherwise, containing one or more double bonds, containing from about 2 to about 20 carbon atoms and preferably from about 3 to about 6. The double bonds are preferably conjugated and/or associated at least with an activating group situated in the a position.

This class of bonding agents corresponding to the following Formula V can also be employed in the rubber compositions with at least one radical initiator, preferably consisting of at least one peroxide.

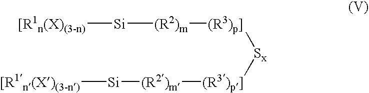

in which R¹, R^{1′}, X, X′, R², R^{2′}, n, n′, m, m′, R³, R^{3′}, p and p′ are identical or different and correspond to the same definitions set forth in Formula I; x is an integer from 1 to 8; Sx therefore denotes a mono-, di- or polysulfide radical, with the condition of not simultaneously having n=n′, m=m′, p=p′, X=X′, R¹=R^{1′}, R²=R^{2′} and R³=R^{3′}.

Examples of the organosilane compounds for use herein include, but are not limited to, vinyltrichlorosilane, vinyltrimethoxysilane, vinyltriethoxysilane, vinyltris(β-methoxyethoxy) silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, -β(aminoethyl)-γ-aminopropylmethyldimethoxysilane, N-β-(aminoethyl)γ-aminopropyltrimethoxysilane, N-β(aminoethyl)γ-aminopropyltriethoxysilane, γ-aminopropyltrimethoxysilane, γ-aminopropyltriethoxysilane, -phenyl-γ-aminopropyltrimethoxysilane, γ-chloropropyltrimethoxysilane, 3,3′-bis(trimethoxysilylpropyl) disulfide, 3,3′-bis(triethoxysilylpropyl) disulfide, 3,3-bis(triethoxysilylpropyl) tetrasulfide, 3,3′-bis(triethoxysilylpropyl) octasulfide, 3,3′-bis(trimethoxysilylpropyl) tetrasulfide, 2,2′-bis(triethoxysilylethyl) tetrasulfide, 3,3′-bis(trimethoxysilylpropyl) trisulfide, 3,3′-bis(triethoxysilylpropyl) trisulfide, 3,3′-bis(tributoxysilylpropyl) disulfide, 3,3′-bis(trimethoxysilylpropyl) hexasufide, 3,3′-bis(trimethoxysilylpropyl) octasulfide, 3,3′-bis(trioctoxysilylpropyl) tetrasulfide, 3,3′-bis(trihexoxysilylpropyl) disulfide, 3,3′-bis(tri-2″-ethylhexoxysilylpropyl) trisulfide, 3,3′-bis(triisooctoxysilyipropyl) tetrasulfide, 3,3′-bis(tri-t-butoxysilyl-propyl) disulfide, 2,2′-bis(methoxydiethoxysilylethyl) tetrasulfide, 2,2′-bis(tripropoxysilylethyl) pentasulfide, 3,3′-bis(tricyclohexoxysi lylpropyl) tetrasulfide, 3,3′-bis(tricyclopentoxysilylpropyl) trisulfide, 2,2′-bis(tri-2″-methyl-cyclohexoxysilylethyl) tetrasulfide, bis(trimethoxysilylmethyl) tetrasulfide, 3-methoxy ethoxy propoxysilyl 3′-diethoxybutoxy-silylpropyltetrasulfide, 2,2′-bis(dimethyl methoxysilylethyl) disulfide, 2,2′-bis(dimethyl sec.butoxysilylethyl) trisulfide, 3,3′-bis(methylbutylethoxysilylpropyl) tetrasulfide, 3,3′-bis(di t-butylmethoxysilylpropyl) tetrasulfide, 2,2′-bis(phenylmethylmethoxysilylethyl) trisulfide, 3,3′-bis(diphenylisopropoxysilylpropyl) tetrasulfide, 3,3′-bis(diphenyl cyclohexoxysilylpropyl) disulfide, 2,2′-bis(methyldimethoxysilylethyl) trisulfide, 2,2′-bis(methyl ethoxypropoxysilylethyl) tetrasulfide, 3,3′-bis(diethylmethoxysilylpropyl) tetrasulfide, 3,3′-bis(ethyl di-sec. butoxysilylpropyl) disulfide, 3,3′-bis(propyldiethoxysilylpropyl) disulfide, 3,3′-bis(butyl dimethoxysilyipropyl) trisulfide, 3,3′-bis(phenyl dimethoxysilylpropyl) tetrasulfide, 3-phenylethoxybutoxysilyl 3′-trimethoxysilyipropyl tetrasulfide, 4,4′-bis(trimethoxysilylbutyl) tetrasulfide, 6,6′-bis(triethoxysilylhexyl) tetrasulfide, 12,12′-bis(triisopropoxysilyldodecyl) disulfide, 18,18′-bis(trimethoxysilyloctadecyl) tetrasulfide, 18,18′-bis(tripropoxysilyl-octadecenyl) tetrasulfide, 4,4′-bis(trimethoxysilyl-butene-2-yl) tetrasulfide, 4,4′-bis(trimethoxysilylcyclohexylene) tetrasulfide, 5,5′-bis(dimethoxymethyl-silylpentyl) trisulfide, 3,3′-bis(trimethoxysilyl-2-methylpropyl) tetrasulfide, 3,3′-bis(dimethoxyphenylsilyl-2-methylpropyl) disulfide and the like. Preferred organosilane compounds for use herein are 3,3′-bis(triethoxysilylpropyl) disulfide and 3,3′-bis(triethoxysilylpropyl) tetrasulfide.

Generally, such mixtures, for example, may be premixed, or pre-reacted, with the silica particles or added to the rubber mix during the rubber/silica/thiuram disulfide processing, or mixing, stage. If the mixtures and silica are added separately to the rubber mix during the rubber/silica mixing, or processing stage, it is considered that the mixtures then combines in situ with the silica.

In particular, such mixtures are generally composed of a silane which has a constituent component, or moiety, (the silane portion) capable of reacting with the silica surface and, also, a constituent component, or moiety, capable of reacting with the rubber, e.g., a sulfur vulcanizable rubber which contains carbon-to-carbon double bonds, or unsaturation. In this manner, then, the mixtures acts as a connecting bridge between the silica and the rubber thereby enhancing the rubber reinforcement aspect of the silica.

The silane component(s) of the mixtures apparently forms a bond to the silica surface, possibly through hydrolysis, and the rubber reactive component(s) of the mixtures combines with the rubber itself. Generally, the rubber reactive component(s) of the mixtures is temperature sensitive and tends to combine with the rubber during the final and higher temperature sulfur vulcanization stage, i.e., subsequent to the rubber/silica/coupling mixing stage and after the silane group of the coupling agent has combined with the silica. However, partly because of typical temperature sensitivity of the reinforcing additive, some degree of combination, or bonding, may occur between the rubber-reactive component of the reinforcing additive and the rubber during an initial rubber/silica/reinforcing additive mixing stage and prior to a subsequent vulcanization stage. When compounding the reinforcing additive into the rubber composition, the foregoing functionalized mercaptosilane compounds are advantageously present in amounts ranging from about 0.1 to about 5, preferably from about 0.2 to about 3 and most preferably from about 0.3 to about 2 while the foregoing functionalized organosilane compounds are present in amounts ranging from about 0.5 to about 10, preferably from about 1 to about 8 and most preferably from about 1.5 to about 7.

The high molecular weight thiuram disulfide accelerators for use in the rubber composition of this invention as a secondary accelerator advantageously provide a rubber composition possessing a greater safety scorch. The thiuram disulfides herein will have a weight average molecular weight of at least 400, preferably from about 500 to about 1250 and most preferably from about 800 to about 1000. Representative of these thiuram disulfides are those of the general formula

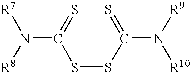

wherein R⁷, R⁸, R⁹ and R¹⁰ each are the same or different and are hydrocarbons containing, for example, from about 4 to about 30 carbon atoms, optionally containing one or more heterocyclic groups, or R⁷and R⁸ and/or R⁹ and R¹⁰ together with the nitrogen atom to which they are bonded are joined together to form a heterocyclic group, optionally containing one or more additional heterocyclic atoms. Specific thiuram disulfides include those in which R⁷, R⁸, R⁹ and R¹⁰ are independently selected to be t-butyl, pentyl, hexyl, cyclohexyl, heptyl, octyl, 2-ethylhexyl, nonyl, decyl, undecyl, dodecyl, stearyl, oleyl, phenyl, benzyl, tridecyl, tetradecyl, pentadecyl, hexadecyl, heptadecyl, octadecyl, nonadecyl, eicosanyl, and the like. It is particularly advantageous to employ a thiuram disulfide wherein R⁷, R⁸, R⁹ and R¹⁰ each possess between about 8 to about 18 carbon atoms. A particularly preferred thiuram disulfide for use herein is wherein R⁷, R⁸, R⁹ and R¹⁰ each possess between about 12 and about 14 carbon atoms.

Generally, the thiuram disulfide accelerators are present in the rubber composition of this invention in an amount effective to improve the scorch safety of the composition. The amounts of the thiuram disulfide ordinarily range from about 0.05 to about 2 phr, preferably from about 0.1 to about 1.5 phr and most preferably from about 0.20 to about 1.0 phr.

It is also advantageous to employ an activator for the foregoing high molecular weight thiuram disulfides when forming the rubber compositions of this invention. Useful activators include, but are not limited to, one or more polyoxyalkylene oxides, fatty acids such as stearic acid, zinc oxide and the like. Suitable polyalkylene oxides for use herein can be a polyalkylene oxide which is a polyether of the general formula X(R—O—)ₙH where R may be one or more of the following groups: methylene, ethylene, propylene or tetramethylene group; n is an integer of from 1 to about 50, preferably from about 2 to about 30 and most preferably from about 4 to about 20; and X is a non-aromatic starter molecule containing 1 to about 12 and preferably 2 to 6 functional groups. Representative of the polyalkylene oxides include, but are not limited to, dimethylene glycol, diethylene glycol, dipropylene glycol, trimethylene glycol, triethylene glycol, tripropylene glycol, polyethylene oxide, polypropylene oxide, polybutylene oxide and the like and mixtures thereof. A preferred activator for use herein is diethlyene glycol.

By employing an effective amount of the foregoing activators, the amount of thiuram disulfide necessary to form the rubber composition is reduced thereby providing an economical advantage. Also, the activators used herein and particularly diethylene glycol when employed in an effective amount advantageously decrease the cure time of the rubber compositions of this invention when added thereto. Accordingly, an effective amount of the activator(s) will ordinarily range from about 0.25 to about 10 phr, preferably from about 0.5 to about 7 phr and most preferably from about 0.75 to about 5 phr.

The rubber compositions of this invention can be formulated in any conventional manner. Additionally, at least one other common additive can be added to the rubber compositions of this invention, if desired or necessary, in a suitable amount. Suitable common additives for use herein include vulcanizing agents, retarders, antioxidants, plasticizing oils and softeners, fillers other than silica and carbon black, reinforcing pigments, antiozonants, waxes, tackifier resins, and the like and combinations thereof.

The rubber compositions of this invention are particularly useful when manufactured into articles such as, for example, tires, motor mounts, rubber bushings, power belts, printing rolls, rubber shoe heels and soles, rubber floor tiles, caster wheels, elastomer seals and gaskets, conveyor belt covers, hard rubber battery cases, automobile floor mats, mud flap for trucks, ball mill liners, windshield wiper blades and the like. Preferably, the rubber compositions of this invention are advantageously used in a tire as a component of any or all of the thermosetting rubber-containing portions of the tire. These include the tread, sidewall, and carcass portions intended for, but not exclusive to, a truck tire, passenger tire, off-road vehicle tire, vehicle tire, high speed tire, and motorcycle tire that also contain many different reinforcing layers therein. Such rubber or tire tread compositions in accordance with the invention may be used for the manufacture of tires or for the re-capping of worn tires.

### EXAMPLES

The following non-limiting examples are intended to further illustrate the present invention and are not intended to limit the scope of the invention in any manner.

### Comparative Examples A and B and Examples 1-4

Employing the ingredients indicated in Table II (which are listed in parts per hundred of rubber by weight), several rubber compositions were compounded in the following manner: In the first cycle mixing stage, the rubber components were added with silica, carbon black, coupling agents, diethylene glycol and oil in a mixer and mixed together. Mixing was continued until a temperature of 150° C. was reached, and then extended 3 more minutes at 150° C. to 155° C. by adjusting RPM. The mixed batch was discharged at 155° C. In the second cycle mixing stage, zinc oxide, stearic acid, Flexzone 7P, Naugard Q, and wax was mixed with the resulting first cycle mixed master batch. Mixing was continued until a temperature of 145° C. was reached, and then the mixed batch was discharged at 145° C. In the final cycle mixing stage, accelerators and sulfurs was mixed with the second cycle mixed batch until a temperature of 105° C. was reached. Next, the mixture was discharged at a temperature of 105° C.

TABLE II

| | Comp.Ex./Ex. | | | | | |
|---|---|---|---|---|---|---|
| | A | B | 1 | 2 | 3 | 4 |
| SOLFLEX 1216¹ | 75.00 | 75.00 | 75.00 | 75.00 | 75.00 | 75.00 |
| BUDENE 1207² | 25.00 | 25.00 | 25.00 | 25.00 | 25.00 | 25.00 |
| ZEOSIL 1165¹ | 85.00 | 85.00 | 85.00 | 85.00 | 85.00 | 85.00 |
| N234 BLACK⁴ | 5.00 | 5.00 | 5.00 | 5.00 | 5.00 | 5.00 |
| SUNDEX 8125⁵ | 44.00 | 44.00 | 44.00 | 44.00 | 44.00 | 44.00 |
| SILQUEST A1289⁶ | 6.80 | 4.50 | 4.00 | 3.50 | 3.50 | 0.00 |
| SILQUEST A-1891⁷ | 0.00 | 0.00 | 0.50 | 1.00 | 0.60 | 0.00 |
| DIETHYLENE | 0.00 | 2.30 | 2.30 | 2.30 | 2.30 | 0.00 |
| GLYCOL | | | | | | |
| BLENDS⁸ | 0.00 | 0.00 | 0.00 | 0.00 | 0.00 | 6.80 |
| STEARIC ACID | 1.00 | 1.00 | 1.00 | 1.00 | 1.00 | 1.00 |
| FLEXZONE 7P⁹ | 1.00 | 1.00 | 1.00 | 1.00 | 1.00 | 1.00 |
| NAUGARD Q¹⁰ | 1.00 | 1.00 | 1.00 | 1.00 | 1.00 | 1.00 |
| ZINC OXIDE¹¹ | 4.00 | 4.00 | 4.00 | 4.00 | 4.00 | 4.00 |
| SUNPROOF | 0.50 | 0.50 | 0.50 | 0.50 | 0.50 | 0.50 |
| IMPROVED WAX | | | | | | |
| DELAC NS¹² | 1.50 | 1.50 | 1.50 | 1.50 | 1.50 | 1.50 |
| DIPHENYL | 2.00 | 0.00 | 0.00 | 0.00 | 0.00 | 0.00 |
| GUANIDINE | | | | | | |
| ROYALAC 150¹³ | 0.00 | 0.50 | 0.50 | 0.50 | 0.50 | 0.50 |
| SUFUR 21-10¹⁴ | 2.00 | 2.50 | 2.50 | 2.50 | 2.50 | 2.50 |

¹Solution styrene-butadiene rubber low styrene and medium vinyl content available from Goodyear.
²Polybutadiene rubber available from Goodyear.
³Highly dispersable silica available from Rhodia.
⁴High surface area carbon black available from Cabot Corp.
⁵Aromatic oil available from Sun Oil.
⁶Tetrasulfide silane coupling agent available from OSI Specialty Chemicals.
⁷Mercapto silane coupling agent from OSI Specialty Chemicals.
⁸3.5 phr of Silquest A-1289, 1 phr of Silquest A-1891 and 2.3 phr of diethylene glycol.
⁹ Paraphenylene diamine available from Uniroyal Chemical Company.
¹⁰TMQ, an antioxidant available from Uniroyal Chemical Company.
¹¹Zinc oxide available from C. P. Hall.
¹²N-t-butyl-2-benzothiazole sulfenamide available from Uniroyal Chemical Company.
¹³Tetraalkyl(C₁₂-C₁₄) thiuramdisulfide available from Uniroyal Chemical Company having an average molecular weight of 916.
¹⁴Sulfur available from C. P. Hall.

Results

The compounded stocks prepared above were then sheeted out and cut for cure. The samples were cured for the times and at the temperatures indicated in Table III and their physical properties evaluated. The results are summarized in Table III below. Note that in Table III, cure characteristics were determined using a Monsanto rheometer ODR 2000 (1° ARC, 100 cpm): MH is the maximum torque and ML is the minimum torque. Scorch safety (tₛ2) is the time to 2 units above minimum torque (ML), cure time (t₅₀) is the time to 50% of delta torque above minimum and cure time (t₉₀) is the time to 90% of delta torque above minimum. Tensile Strength, Elongation and Modulus were measured following procedures in ASTM D-412. Examples 1-4 illustrate a rubber composition within the scope of this invention. Comparative Examples A and B illustrate a rubber compositions outside the scope of this invention.

TABLE III

| | Com. Ex./Ex. | | | | | |
|---|---|---|---|---|---|---|
| | A | B | 1 | 2 | 3 | 4 |
| Mooney | | | | | | |
| Viscosity | | | | | | |
| (Viscosity | | | | | | |
| (ML₁₊₄ at | | | | | | |
| 100° C.) | | | | | | |
| ML₁₊₄ | 71.00 | 74.00 | 76.00 | 78.00 | 72.00 | 73.00 |
| Mooney Scorch | | | | | | |
| (MS at | | | | | | |
| 135° C.) | | | | | | |
| 3 Pt. Rise Time | 5.92 | 18.90 | 19.16 | 19.19 | 20.23 | 20.01 |
| (min) | | | | | | |
| 18 Pt. Rise | 12.15 | 22.61 | 22.47 | 22.32 | 23.21 | 23.02 |
| Time (min) | | | | | | |
| Cured | | | | | | |
| Characteristics | | | | | | |
| obtained | | | | | | |
| at 160° C. | | | | | | |
| MH (lb-in.) | 39.59 | 47.33 | 50.59 | 48.41 | 46.58 | 48.22 |
| ML (lb-in.) | 7.80 | 11.01 | 11.38 | 11.15 | 10.81 | 10.38 |
| Scorch safety | 1.97 | 3.31 | 3.12 | 2.81 | 3.27 | 2.73 |
| tₛ2 (min) | | | | | | |
| Cure time | 4.12 | 6.91 | 7.01 | 6.84 | 6.79 | 6.84 |
| T₅₀ (min) | | | | | | |
| Cure time | 20.19 | 13.54 | 16.56 | 15.64 | 15.33 | 17.35 |
| T₉₀ (min) | | | | | | |
| Cure Time | 22.00 | 16.00 | 18.00 | 18.00 | 17.00 | 19.00 |
| at 160° C.(min) | | | | | | |
| Tensile | 20.17 | 20.83 | 20.50 | 19.42 | 19.68 | 20.48 |
| Strength at RT | | | | | | |
| (Mpa) | | | | | | |
| Elongation, | 415.00 | 443.00 | 413.00 | 384.00 | 404.00 | 380.00 |
| % at Break | | | | | | |
| 100% Modulus | 2.30 | 2.40 | 2.50 | 2.32 | 2.35 | 2.52 |
| (Mpa) | | | | | | |
| 200% Modulus | 6.19 | 6.51 | 6.87 | 6.65 | 6.55 | 7.56 |
| (Mpa) | | | | | | |
| 300% Modulus | 12.10 | 12.43 | 13.37 | 13.44 | 12.81 | 14.86 |
| (Mpa) | | | | | | |
| Hardness, | 62.00 | 70.00 | 65.00 | 67.00 | 67.00 | 65.00 |
| Shore A. | | | | | | |
| Tear Die C | 30.78 | 36.41 | 34.53 | 32.82 | 36.20 | 30.72 |
| (KN/m) | | | | | | |
| M300/M100 | 5.26 | 5.20 | 5.35 | 5.79 | 5.45 | 5.89 |
| Din Abrasion | 139.50 | 127.50 | 137.20 | 140.00 | 135.00 | 135.60 |
| Index | | | | | | |
| Aged 2 weeks | | | | | | |
| at 70° C. | | | | | | |
| Tensile | 20.05 | 16.61 | 18.12 | 16.62 | 18.09 | 19.09 |
| Strength | | | | | | |
| at RT (Mpa) | | | | | | |
| Elongation, | 327.00 | 252.00 | 263.00 | 239.00 | 263.00 | 260.00 |
| % at Break | | | | | | |
| 200% Modulus | 3.59 | 4.68 | 4.63 | 4.55 | 4.35 | 4.58 |
| (Mpa) | | | | | | |
| 300% Modulus | 9.98 | 12.22 | 12.59 | 12.96 | 12.33 | 13.44 |
| (Mpa) | | | | | | |
| Hardness, | 67.00 | 75.00 | 74.00 | 70.00 | 75.00 | 72.00 |
| Shore A. | | | | | | |
| Tear Die | 32.70 | 31.80 | 32.00 | 28.17 | 33.15 | 27.75 |
| C(KN/m) | | | | | | |
| Tangent Delta | | | | | | |
| 60° C. | | | | | | |
| (10 Hz) | | | | | | |
| [RPA-2000] | | | | | | |
| % Strain | | | | | | |
| 0.7 | 0.092 | 0.082 | 0.072 | 0.081 | 0.083 | 0.088 |
| 1.0 | 0.099 | 0.089 | 0.09 | 0.089 | 0.091 | 0.094 |
| 2.0 | 0.122 | 0.111 | 0.107 | 0.109 | 0.109 | 0.113 |
| 5.0 | 0.165 | 0.152 | 0.141 | 0.141 | 0.141 | 0.149 |
| 7.0 | 0.162 | 0.153 | 0.139 | 0.141 | 0.14 | 0.143 |
| 14.0 | 0.161 | 0.162 | 0.154 | 0.150 | 0.156 | 0.154 |

It can be seen from the above data that the examples containing both a mercaptosilane compound and an organosilane compound other than a mercaptosilane compound as the reinforcing additives together with a high molecular weight thiuram disulfide (Examples 1-4) provide a rubber composition having improved performance when compared to the examples containing a tetrasulfide silane reinforcing additive alone with no high molecular weight thiuram disulfide present therein (Comparative Example A) and a tetrasulfide silane reinforcing additive alone with a high molecular weight thiuram disulfide (Comparative Example B). The Mooney Scorch values for Examples 1-4 were higher than those of Comparative Examples A and B while also having increased scorch safety. Additionally, the 100% and 300% Modulus and % elongation for Examples 1-4 are comparable to those of Examples A-D.

Although the invention has been described in its preferred form with a certain degree of particularity, obviously many changes and variations are possible therein and will be apparent to those skilled in the art after reading the foregoing description. It is therefore to be understood that the present invention may be presented otherwise than as specifically described herein without departing from the spirit and scope thereof.

What is claimed is:

1. A rubber composition comprising (a) a rubber component; (b) silica as a reinforcing filler; (c) a reinforcing additive comprising a mixture and/or the product of in situ reaction of (i) at least one functionalized mercaptosilane compound containing, per molecule, at least one functional group capable of bonding chemically and/or physically with the surface hydroxyl sites of the silica filler and at least one other functional group capable of bonding chemically and/or physically to the chains of the rubber component and (ii) at least one functionalized organosilane compound, other than a mercaptosilane compound, containing, per molecule, at least one functional group capable of bonding chemically and/or physically with the mercaptosilane compound and/or the hydroxyl sites of the silica filler and at least one other functional group capable of bonding chemically and/or physically to the chains of the rubber component; and (d) an effective amount of a thiuram disulfide accelerator having a molecular weight of at least about 400.

2. The rubber composition of claim 1 wherein the rubber component is selected from the group consisting of natural rubber, homopolymers of conjugated diolefins, copolymers of conjugated diolefins and ethylenically unsaturated monomers and mixtures thereof.

3. The rubber composition of claim 1 wherein the rubber component is selected from the group consisting of natural rubber, cis-polyisoprene, polybutadiene, poly(styrene-butadiene), styrene-isoprene copolymers, isoprenebutadiene copolymers, styrene-isoprene-butadiene tripolymers, polychloropene, chloro-isobutene-isoprene, nitrile-chloroprene, styrene-chloroprene, poly(acrylonitrile-butadiene) and ethylene-propylene-diene terpolymer.

4. The rubber composition of claim 1 wherein the silica filler is selected from the group consisting of silica, precipitated silica, amorphous silica, vitreous silica, fumed silica, fused silica, synthetic silicate, alkaline earth metal silicate, highly dispersed silicate and mixtures thereof.

5. The rubber composition of claim 1 wherein the functionalized mercaptosilane compound of the reinforcing additive is of the general formula: 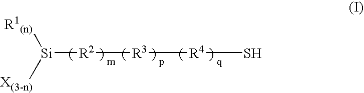
wherein R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a hydroxyl group (OH); R² is a divalent hydrocarbon group chosen from linear or branched alkyls containing from 1 to about 10 carbon atoms and m is 0 or 1; R³ is a hydrocarbon group chosen from aryls containing from about 5 to about 12 carbon atoms; with the condition that p and m are not equal to 0 simultaneously; q is 0 or 1 and R⁴ is

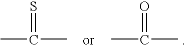

6. The rubber composition of claim 1 wherein the functionalized mercaptosilane compounds are selected from the group consisting of 3-mercaptopropyltrimethoxysilane, 3-mercpaptopropyltriethoxysilane, 3-mercaptopropylmethyldimethoxysilane, 2-mercaptoethyltriethoxysilane, 2-mercaptoethylmethyldiethoxysilane, mercaptomethyldimethylethoxysilane, mercaptomethyltrimethoxysilane, mercaptopropyldimethylmethoxysilane, 3-mercaptopropylphenyldimethoxysilane, 3-mercaptopropyltrimethylsilane, mercaptomethylmethyldiethoxysilane, mercaptoethyltrimethoxyethoxysilane, and mixtures thereof.

7. The rubber composition of claim 1 wherein the functionalized organosilane compounds is selected from the compounds corresponding to the following formulae (II)-(V): 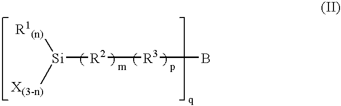
in which R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a hydroxyl group (OH); R² is a divalent hydrocarbon group chosen from linear or branched alkyls containing from 1 to about 10 carbon atoms and m is 0 or 1; R³ is a hydrocarbon group chosen from aryls containing from about 5 to about 12 carbon atoms; with the condition that p and m are not equal to 0 simultaneously; q is 1 or 2 and B denotes a group other than S—H capable of forming a bond with at least one of the rubber components of the rubber composition, wherein:
if q=2: B is a polysulfide functional group chosen from the following groups:
—Sx— with 1≦x≦8 and x is a positive integer, 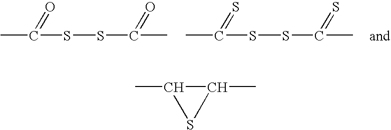
if q=1: B is a function group chosen from the following groups: 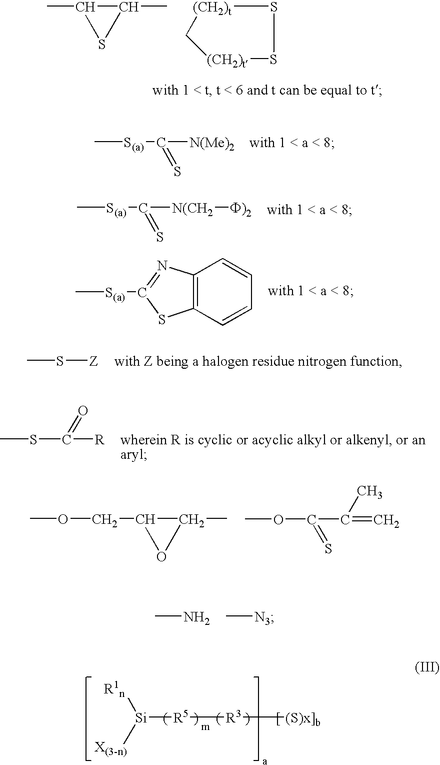
in which R¹ and X have the aforestated meanings as set forth in Formula (II), 0≦x≦2, R⁵ denotes a divalent hydrocarbon group chosen from linear or branched alkyls and alkylenoxys, containing from 1 to about 10 carbon atoms, m denotes 0 or 1, R³ denotes a hydrocarbon group chosen from aryls containing from about 6 to about 12 carbon atoms, and (S)ₓ is a divalent polysulfured radical, each free valency being bonded directly to a carbon atom of an aromatic ring, it being possible for a number of aromatic rings to be linked together by the radical (S)x, 2≦x≦6, a≧2 and b≧1 with 0.4≦a/b≦2; 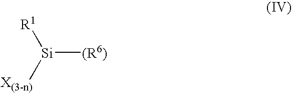
in which R¹ and X have the aforestated meanings as set forth in Formula (II), 0≦n≦2, R⁶ is a C₂ to C₂₀ linear or branched hydrocarbon group, cyclic or otherwise, containing one or more double bonds; and 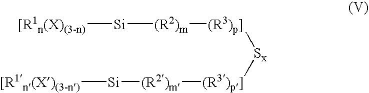
in which each pair of symbols R¹ and R^{1′}, X and X′, R² and R^{2′}, n and n′, m and m′, R³, and R^{3′}, and p and p′ have equivalent definitions, wherein each can be identical or different from the other in the pair, and correspond to the same definitions set forth in Formula (II) for R¹, X, R², n, m, R³, and p; x is an integer from 1 to 8; and with the condition of not simultaneously having n=n′, m=m′, p=p′, X=X′, R¹=R^{1′}, R³=R^{3′} and R²=R^{2′}.

8. The rubber composition of claim 7 wherein the organosilane compound is selected from the group consisting of bis(tri-C₁-C₄-alkoxysilylpropyl) disulfide, bis((tri-C₁-C₄-alkoxysilylpropyl) tetrasulfide and mixtures thereof.

9. The rubber composition of claim 1 wherein the thiuram disulfide accelerator is of the general formula 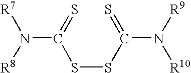
wherein R⁷, R⁸, R⁹ and R¹⁰ each are the same or different and are hydrocarbons containing from about 4 to about 30 carbon atoms, optionally containing one or more heterocyclic groups, or R⁷ and R⁸ and/or R⁹ and R¹⁰ together with the nitrogen atom to which they are bonded are joined together to form a heterocyclic group, optionally containing one or more additional heterocyclic atoms.

10. The rubber composition of claim 9 wherein R⁷, R⁸, R⁹ and R¹⁰ each are the same or different and are hydrocarbons containing from about 8 to about 18 carbon atoms.

11. The rubber composition of claim 9 wherein R⁷, R⁸, R⁹ and R¹⁰ each are the same or different and are hydrocarbons containing from about 12 to about 14 carbon atoms.

12. The rubber composition of claim 11 wherein the functionalized mercaptosilane compounds are selected from the group consisting of 3-mercaptopropyltrimethoxysilane, 3-mercpaptopropyltriethoxysilane, 3-mercaptopropylmethyldimethoxysilane, 2-mercaptoethyltriethoxysilane, 2-mercaptoethylmethyldiethoxysilane, mercaptomethyldimethylethoxysilane, mercaptomethyltrimethoxysilane, mercaptopropyldimethylmethoxysilane, 3-mercaptopropylphenyldimethoxysilane, 3-mercaptopropyltrimethylsilane, mercaptomethylmethyldiethoxysilane, mercaptoethyltrimethoxyethoxysilane, and mixtures thereof and the organosilane compound is selected from the group consisting of bis(tri-C₁-C₄-alkoxysilylpropyl) disulfide, bis((tri-C₁-C₄-alkoxysilylpropyl) tetrasulfide and mixtures thereof.

13. The rubber composition of claim 1 further comprising one or more activators for the thiuram disulfide.

14. The rubber composition of claim 13 wherein the activator is a polyalkylene oxide.

15. The rubber composition of claim 14 wherein the activator is diethylene glycol.

16. The rubber composition of claim 1 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.

17. A method for making a rubber composition having improved scorch safety and hysteretic properties comprising the step of forming a rubber composition comprising (a) a rubber component; (b) silica as a reinforcing filler; (c) a reinforcing additive comprising a mixture and/or the product of in situ reaction of (i) at least one functionalized mercaptosilane compound containing, per molecule, at least one functional group capable of bonding chemically and/or physically with the surface hydroxyl sites of the silica filler and at least one other functional group capable of bonding chemically and/or physically to the chains of the rubber component and (ii) at least one functionalized organosilane compound, other than a mercaptosilane compound, containing, per molecule, at least one functional group capable of bonding chemically and/or physically with the mercaptosilane compound and/or the hydroxyl sites of the silica filler and at least one other functional group capable of bonding chemically and/or physically to the chains of the rubber component; and (d) an effective amount of a thiuram disulfide accelerator having a molecular weight of at least about 400.

18. The method of claim 17 wherein the rubber component is selected from the group consisting of natural rubber, homopolymers of conjugated diolefins, copolymers of conjugated diolefins and ethylenically unsaturated monomers and mixtures thereof.

19. The method of claim 17 wherein the rubber component is selected from the group consisting of natural rubber, cis-polyisoprene, polybutadiene, poly(styrene-butadiene), styrene-isoprene copolymers, isoprenebutadiene copolymers, styrene-isoprene-butadiene tripolymers, polychloropene, chloro-isobutene-isoprene, nitrile-chloroprene, styrene-chloroprene, poly(acrylonitrile-butadiene) and ethylene-propylene-diene terpolymer.

20. The method of claim 17 wherein the silica filler is selected from the group consisting of silica, precipitated silica, amorphous silica, vitreous silica, fumed silica, fused silica, synthetic silicate, alkaline earth metal silicate, highly dispersed silicate and mixtures thereof.

21. The method of claim 17 wherein the functionalized mercaptosilane compound of the reinforcing additive is of the general formula: 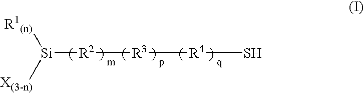
wherein R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a hydroxyl group (OH); R² is a divalent hydrocarbon group chosen from linear or branched alkyls containing from 1 to about 10 carbon atoms and m is 0 or 1; R³ is a hydrocarbon group chosen from aryls containing from about 5 to about 12 carbon atoms; with the condition that p and m are not equal to 0 simultaneously; q is 0 or 1 and R⁴ is

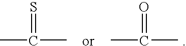

22. The method of claim 17 wherein the functionalized mercaptosilane compounds are selected from the group consisting of 3-mercaptopropyl-trimethoxysilane, 3-mercpaptopropyltriethoxysilane, 3-mercaptopropylmethyl-dimethoxysilane, 2-mercaptoethyltriethoxysilane, 2-mercaptoethylmethyldiethoxysilane, mercaptomethyld imethylethoxysilane, mercaptomethyltrimethoxysilane, mercaptopropyldimethylmethoxysilane, 3-mercaptopropylphenyldimethoxysilane, 3-mercaptopropyltrimethylsilane, mercaptomethylmethyldiethoxysilane, mercaptoethyltrimethoxyethoxysilane, and mixtures thereof.

23. The method of claim 17 wherein the functionalized organosilane compounds is selected from the compounds corresponding to the following formulae (II)-(V): 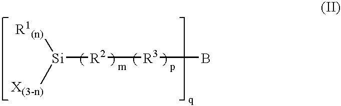
in which R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a hydroxyl group (OH); R² is a divalent hydrocarbon group chosen from linear or branched alkyls containing from 1 to about 10 carbon atoms and m is 0 or 1; R³ is a hydrocarbon group chosen from aryls containing from about 5 to about 12 carbon atoms; with the condition that p and m are not equal to 0 simultaneously; q is 1 or 2 and B denotes a group other than S—H capable of forming a bond with at least one of the rubber components of the rubber composition, wherein:
if q=2: B is a polysulfide functional group chosen from the following groups:
—Sx— with 1≦x≦8 and x is a positive integer, 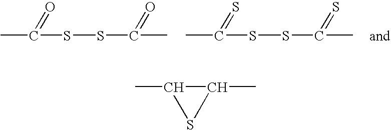
if q=1: B is a function group chosen from the following groups: 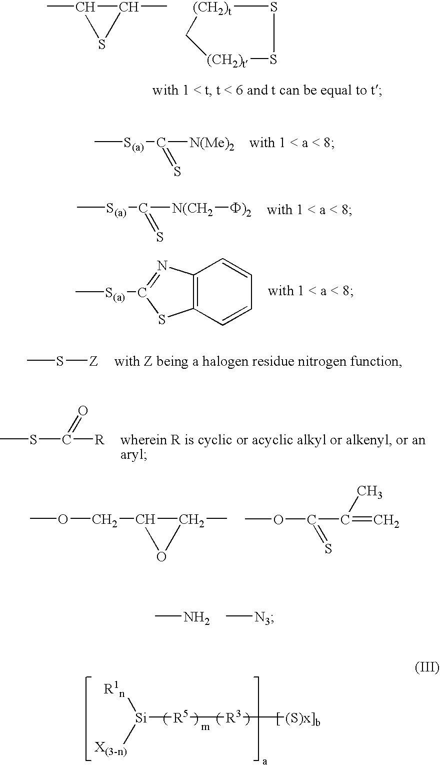
in which R¹ and X have the aforestated meanings as set forth in Formula (II), 0≦x≦2, R⁵ denotes a divalent hydrocarbon group chosen from linear or branched alkyls and alkylenoxys, containing from 1 to about 10 carbon atoms, m denotes 0 or 1, R³ denotes a hydrocarbon group chosen from aryls containing from about 6 to about 12 carbon atoms, and (S)ₓ is a divalent polysulfured radical, each free valency being bonded directly to a carbon atom of an aromatic ring, it being possible for a number of aromatic rings to be linked together by the radical (S)x, 2≦x≦6, a≧2 and b≧1 with 0.4≦a/b≦2; 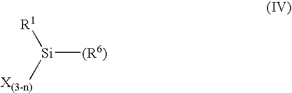
in which R¹ and X have the aforestated meanings as set forth in Formula (II), 0≦n≦2, R⁶ is a C₂ to C₂₀ linear or branched hydrocarbon group, cyclic or otherwise, containing one or more double bonds; and 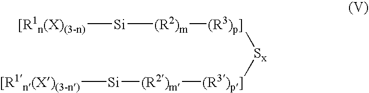
in which each pair of symbols R¹ and R^{1′}, X and X′, R² and R^{2′}, n and n′, m and m′, R³ and R^{3′}, and p and p′ have equivalent definitions, wherein each can be identical or different from the other in the pair, and correspond to the same definitions set forth in Formula (II) for R¹, X, R², n, m, R³, and p; x is an integer from 1 to 8; and with the condition of not simultaneously having n=n′, m=m′, p=p′, X=X′, R¹=R^{1′}, R³=R^{3′} and R²=R^{2′}.

24. The method of claim 23 wherein the organosilane compound is selected from the group consisting of bis(tri-C₁-C₄-alkoxysilylpropyl) disulfide, bis((tri-C₁-C₄-alkoxysilylpropyl) tetrasulfide and mixtures thereof.

25. The method of claim 17 wherein the thiuram disulfide accelerator is of the general formula 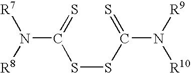
wherein R⁷, R⁸, R⁹ and R¹⁰ each are the same or different and are hydrocarbons containing from about 4 to about 30 carbon atoms, optionally containing one or more heterocyclic groups, or R⁷ and R⁸ and/or R⁹ and R¹⁰ together with the nitrogen atom to which they are bonded are joined together to form a heterocyclic group, optionally containing one or more additional heterocyclic atoms.

26. The method of claim 25 wherein R⁷, R⁸, R⁹ and R¹⁰ each are the same or different and are hydrocarbons containing from about 8 to about 18 carbon atoms.

27. The method of claim 25 wherein R⁷, R⁸, R⁹ and R¹⁰ each are the same or different and are hydrocarbons containing from about 12 to about 14 carbon atoms.

28. The method of claim 27 wherein the functionalized mercaptosilane compounds are selected from the group consisting of 3-mercaptopropyl-trimethoxysilane, 3-mercpaptopropyltriethoxysilane, 3-mercaptopropylmethyl-dimethoxysilane, 2-mercaptoethyltriethoxysilane, 2-mercaptoethylmethyldiethoxysilane, mercaptomethyldimethylethoxysilane, mercaptomethyltrimethoxysilane, mercaptopropyldimethylmethoxysilane, 3-mercaptopropylphenyldimethoxysilane, 3-mercaptopropyltrimethylsilane, mercaptomethylmethyldiethoxysilane, mercaptoethyltrimethoxyethoxysilane, and mixtures thereof and the organosilane compound is selected from the group consisting of bis(tri-C₁-C₄-alkoxysilylpropyl) disulfide, bis((tri-C₁-C₄-alkoxysilylpropyl) tetrasulfide and mixtures thereof.

29. The method of claim 17 further comprising one or more activators for the thiuram disulfide.

30. The method of claim 29 wherein the activator is a polyalkylene oxide.

31. The method of claim 30 wherein the activator is diethylene glycol.

32. An article of manufacture comprising a rubber composition comprising (a) a rubber component; (b) silica as a reinforcing filler; (c) a reinforcing additive comprising a mixture and/or the product of in situ reaction of (i) at least one functionalized mercaptosilane compound containing, per molecule, at least one functional group capable of bonding chemically and/or physically with the surface hydroxyl sites of the silica filler and at least one other functional group capable of bonding chemically and/or physically to the chains of the rubber component and (ii) at least one functionalized organosilane compound, other than a mercaptosilane compound, containing, per molecule, at least one functional group capable of bonding chemically and/or physically with the mercaptosilane compound and/or the hydroxyl sites of the silica filler and at least one other functional group capable of bonding chemically and/or physically to the chains of the rubber component; and (d) an effective amount of a thiuram disulfide accelerator having a molecular weight of at least about 400.

33. The article of manufacture of claim 32 wherein the rubber component is selected from the group consisting of natural rubber, homopolymers of conjugated diolefins, copolymers of conjugated diolefins and ethylenically unsaturated monomers and mixtures thereof.

34. The article of manufacture of claim 32 wherein the rubber component is selected from the group consisting of natural rubber, cis-polyisoprene, polybutadiene, poly(styrene-butadiene), styrene-isoprene copolymers, isoprenebutadiene copolymers, styrene-isoprene-butadiene tripolymers, polychloropene, chloro-isobutene-isoprene, nitrile-chloroprene, styrene-chloroprene, poly(acrylonitrile-butadiene) and ethylene-propylene-diene terpolymer.

35. The article of manufacture of claim 32 wherein the silica filler is selected from the group consisting of silica, precipitated silica, amorphous silica, vitreous silica, fumed silica, fused silica, synthetic silicate, alkaline earth metal silicate, highly dispersed silicate and mixtures thereof.

36. The rubber composition of claim 1 wherein the functionalized mercaptosilane compound of the reinforcing additive is of the general formula: 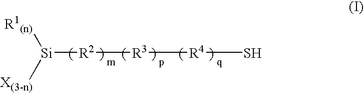
wherein R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a bydroxyl group (OH); R² is a divalent hydrocarbon group chosen from linear or branched alkyls containing from 1 to about 10 carbon atoms and m is 0 or 1; R³ is a hydrocarbon group chosen from aryls containing from about 5 to about 12 carbon atoms; with the condition that p and m are not equal to 0 simultaneously; q is 0 or 1 and R⁴ is

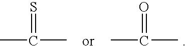

37. The article of manufacture of claim 32 wherein the functionalized mercaptosilane compounds are selected from the group consisting of 3-mercaptopropyltrimethoxysilane, 3-mercpaptopropyltriethoxysilane, 3-mercaptopropylmethyldimethoxysilane, 2-mercaptoethyltriethoxysilane, 2-mercaptoethylmethyldiethoxysilane, mercaptomethyldimethylethoxysilane, mercaptomethyltrimethoxysilane, mercaptopropyldimethylmethoxysilane, 3-mercaptopropylphenyldimethoxysilane , 3-mercaptopropyltrimethyl silane, mercaptomethylmethyldiethoxysilane, mercaptoethyltrimethoxyethoxysilane, and mixtures thereof.

38. The article of manufacture of claim 32 wherein the functionalized organosilane compounds is selected from the compounds corresponding to the following formulae (II)-(V): 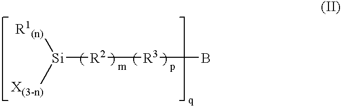
in which R¹ is an alkyl group containing from 1 to about 10 carbon atoms and n is an integer from 0 to 2; X is a hydrolyzable group selected from alkoxy radicals, cycloalkoxy radicals and acyloxy radicals each having from 1 to about 10 carbon atoms or, after hydrolysis, X may optionally denote a hydroxyl group (OH); R² is a divalent hydrocarbon group chosen from linear or branched alkyls containing from 1 to about 10 carbon atoms and m is 0 or 1; R³ is a hydrocarbon group chosen from aryls containing from about 5 to about 12 carbon atoms; with the condition that p and m are not equal to 0 simultaneously; q is 1 or 2 and B denotes a group other than S—H capable of forming a bond with at least one of the rubber components of the rubber composition, wherein:
if q=2: B is a polysulfide functional group chosen from the following groups:
—Sx— with 1≦x≦8 and x is a positive integer, 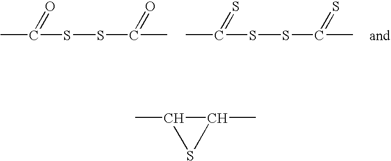
if q=1: B is a function group chosen from the following groups: 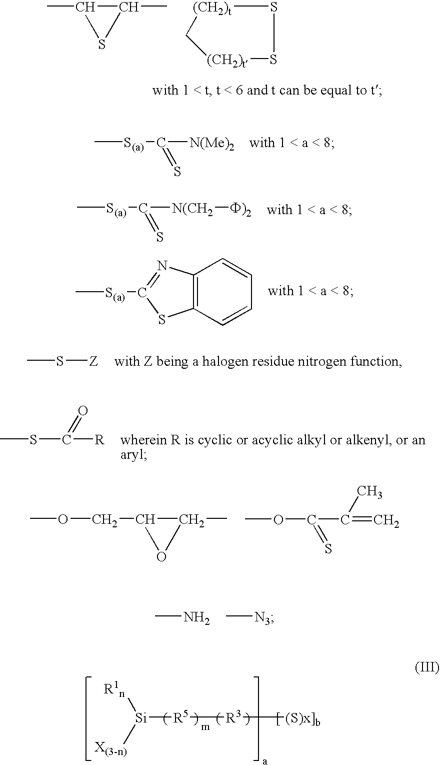
in which R¹ and X have the aforestated meanings as set forth in Formula (II), 0≦x≦2, R⁵ denotes a divalent hydrocarbon group chosen from linear or branched alkyls and alkylenoxys, containing from 1 to about 10 carbon atoms, m denotes 0 or 1, R³ denotes a hydrocarbon group chosen from aryls containing from about 6 to about 12 carbon atoms, and (S)ₓ is a divalent polysulfured radical, each free valency being bonded directly to a carbon atom of an aromatic ring, it being possible for a number of aromatic rings to be linked together by the radical (S)x, 2≦x≦6, a≧2 and b≧1 with 0.4≦a/b≦2; 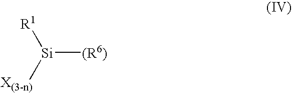
in which R¹ and X have the aforestated meanings as set forth in Formula (II), 0≦n≦2, R⁶ is a C₂ to C₂₀ linear or branched hydrocarbon group, cyclic or otherwise, containing one or more double bonds; and 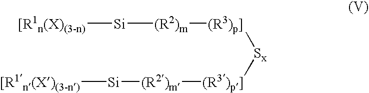
in which each pair of symbols R¹ and R^{1′}, X and X′, R² and R^{2′}, n and n′, m and m′, R³ and R^{3′}, and p and p′ have equivalent definitions, wherein each can be identical or different from the other in the pair, and correspond to the same definitions set forth in Formula (II) for R¹, X, R², n, m, R³, and p; x is an integer from 1 to 8; and with the condition of not simultaneously having n=n′, m=m′, p=p′, X=X′, R¹=R^{1′}, R³=R^{3′} and R²=R^{2′}.

39. The article of manufacture of claim 38 wherein the organosilane compound is selected from the group consisting of bis(tri-C₁-C₄-alkoxysilylpropyl) disulfide, bis((tri-C₁-C₄-alkoxysilylpropyl) tetrasulfide and mixtures thereof.

40. The article of manufacture of claim 32 wherein the thiuram disulfide accelerator is of the general formula 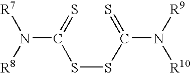
wherein R⁷, R⁸, R⁹ and R¹⁰ each are the same or different and are hydrocarbons containing from about 4 to about 30 carbon atoms, optionally containing one or more heterocyclic groups, or R⁷ and R⁸ and/or R⁹ and R¹⁰ together with the nitrogen atom to which they are bonded are joined together to form a heterocyclic group, optionally containing one or more additional heterocyclic atoms.

41. The article of manufacture of claim 40 wherein R⁷, R⁸, R⁹ and R¹⁰ each are the same or different and are hydrocarbons containing from about 8 to about 18 carbon atoms.

42. The article of manufacture of claim 40 wherein R⁷, R⁸, R⁹ and R¹⁰ each are the same or different and are hydrocarbons containing from about 12 to about 14 carbon atoms.

43. The article of manufacture of claim 41 wherein the functionalized mercaptosilane compounds are selected from the group consisting of 3-mercaptopropyltrimethoxysilane, 3-mercpaptopropyltriethoxysilane, 3-mercaptopropylmethyldimethoxysilane, 2-mercaptoethyltriethoxysilane, 2-mercaptoethylmethyldiethoxysilane, mercaptomethyldimethylethoxysilane, mercaptomethyltrimethoxysilane, mercaptopropyldimethylmethoxysilane, 3-mercaptopropylphenyldimethoxysilane, 3-mercaptopropyltrimethylsilane, mercaptomethylmethyldiethoxysilane, mercaptoethyltrimethoxyethoxysilane, and mixtures thereof and the organosilane compound is selected from the group consisting of bis(tri-C₁-C₄-alkoxysilylpropyl) disulfide, bis((tri-C₁-C₄-alkoxysilylpropyl) tetrasulfide and mixtures thereof.

44. The article of manufacture of claim 32 further comprising one or more activators for the thiuram disulfide.

45. The article of manufacture of claim 43 wherein the activator is diethylene glycol.

46. The article of manufacture of claim 32 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.
